(19) United States
(12) Patent Application Publication
(10) Pub. No.: US 2024/0365839 A1
(43) Pub. Date: Nov. 7, 2024

(54) SAUCE GLAZING APPARATUS AND APPLICATION METHOD

(71) Applicant: Cargill, Incorporated, Wayzata, MN (US)

(72) Inventors: Pacharada CHAIKHEAWGAW, Nan (TH); Preeyanuch CHAIPRASITPHON, Bangkok (TH); Jutamas KHONGPOONVIRUN, Muang Nakhonratchasima (TH)

(21) Appl. No.: 18/580,260

(22) PCT Filed: Jul. 20, 2022
(86) PCT No.: PCT/US2022/073976

§ 371 Date: Jan. 18, 2024

Related U.S. Application Data
(60) Provisional application No. 63/224,053, filed on Jul. 21, 2021.

(51) Int. Cl. A23P 20/17

(52) U.S. Cl. CPC A23P 20/17

(57) ABSTRACT

A method of coating a sauce onto skewered food product, which includes the steps of positioning a skewered food product on a top surface of a lower conveyor, conveying the skewered food product toward a glazing location of an automated glazing machine, wherein the glazing location comprises an upper conveyor comprising a bottom surface and a lower conveyor comprising a top surface, and wherein the upper and lower conveyors are spaced at a distance from each other so that the skewered food products simultaneously contact the bottom surface of the upper conveyor and the top surface of the lower conveyor at the glazing location, and transferring sauce to an outer surface of the skewered food product as it is conveyed through the glazing location.

### CROSS-REFERENCE TO RELATED APPLICATIONS

This application claims the benefit of U.S. Provisional Patent Application No. 63/224,053, filed 21 Jul. 2021, which is hereby incorporated by reference in its entirety.

### TECHNICAL FIELD

The present invention relates generally to an apparatus and method for applying a sauce glazing onto a food product, and more specifically relates to an apparatus and method for applying a coating of sauce (e.g., sweet soy sauce) to skewered food products (e.g., meatballs) moving along a production line.

### BACKGROUND

Tsukune or Japanese-style meatballs are popular food items that can be made of a wide variety of ingredients, such as minced meat (e.g., chicken, pork, fish, or other meat mixtures and/or products), egg, ginger, grated onion, soy sauce, spices, and/or other ingredients. It is desirable for the mixture to be easily formable into individual meat products, such meatballs or patties, after which they can optionally be partially cooked, such as by boiling, grilling, or frying. The meatballs or patties can then be coated with a sauce, which is generally accomplished by brushing the sauce onto the meat products by hand or by dipping each meat product into a sauce. The sauce-coated products may then be frozen and packaged so that a consumer only needs to perform one or more final cooking steps to heat the sauce-coated meat products to a desired temperature for consumption.

At some point between steps of the cooking and coating process, it is common for the meat products to be skewered, such as onto thin bamboo skewers. The skewers provide a convenient way for a consumer to remove each product from its packaging, move it to a cooking site (e.g., a grill), and then eat the product after cooking without having to touch the product with their hands. However, the use of skewers complicates the coating process, as it is desirable for the skewers to be relatively clean or “sauce-free” and for there to be minimal sauce between adjacent meat products. Therefore, dipping the skewered meat products into a container of sauce during the processing thereof is generally not desirable as this will result in the sauce being transferred to the skewer in between meat products and/or to the skewer itself. In addition, it can be difficult for operators to apply a consistent amount of sauce onto the meat products when such application is being done by hand. Thus, there is a there is a desire to provide an apparatus and method of automatically coating a controlled amount of sauce onto skewered food products that provides uniformly coated or glazed products with a desired amount of sauce on their outer surface.

### SUMMARY

Aspects of the invention described herein are directed to a coating apparatus and application method for automatically applying or “glazing” a sauce or coating on a food product, such as skewered meatballs. In embodiments of the invention, the coating process controls the usage of sauce and reduces variability in the amount and location of sauce applied to each food product. Such an apparatus and method can be automated to thereby increase the production capacity as compared to manual coating of the products. In addition, eliminating the need for handling of the products by operators provides fewer chances for contaminants to enter the processing system.

In an embodiment, an automated glazing machine is provided for applying sauce to at least one food product. The glazing machine includes a lower conveyor having a top surface moving in a first direction, an upper conveyor having a bottom surface moving in a second direction that is different from the first direction, wherein the upper conveyor is spaced from the lower conveyor at a glazing location by a distance that allows the at least one food product to simultaneously contact the bottom surface of the upper conveyor and the top surface of the lower conveyor, and a sauce tray positioned below the lower conveyor to transfer sauce to the at least one food product at the glazing location.

The lower conveyor may be a mesh conveyor. The lower conveyor and upper conveyor may be configured to move at the same or different speeds. The glazing machine may further include a sauce supply tube for pumping sauce from a sauce supply tank to the sauce tray.

In an embodiment, a method of coating a sauce onto skewered food products is provided, which includes the steps of positioning a skewered food product on a top surface of a lower conveyor, conveying the skewered food product toward a glazing location of an automated glazing machine, wherein the glazing location comprises an upper conveyor comprising a bottom surface and a lower conveyor comprising a top surface, and wherein the upper and lower conveyors are spaced at a distance from each other so that the skewered food products simultaneously contact the bottom surface of the upper conveyor and the top surface of the lower conveyor at the glazing location, and transferring sauce to an outer surface of the skewered food product as it is conveyed through the glazing location.

With this method, the at least one skewered food product may rotate about a central skewer when being conveyed through the glazing location. The method may further include a step of transferring sauce to a sauce tray positioned under the lower conveyor at the glazing location during the step of transferring sauce to an outer surface of the skewered food product. With this method, sauce may be continually transferred to the sauce tray. The upper and lower conveyors may move in different directions, and may move at the same or different speeds.

These and various other features and advantages will be apparent from a reading of the following detailed description.

### BRIEF DESCRIPTION OF THE DRAWINGS

The present invention will be further explained with reference to the appended Figures, wherein like structure is referred to by like numerals throughout the several views, and wherein:

FIG. 1 is a front view of a skewer of exemplary food products being conveyed after they have been coated using sauce application apparatus and methods described herein;

FIG. 2 is a top view of multiple skewers of exemplary food products being conveyed after they have been coated using sauce application apparatus and methods described herein;

FIG. 3 is a flow chart of an exemplary series of steps for producing food products using the sauce application apparatus and methods described herein;

FIG. 4 is a perspective view of an exemplary embodiment of equipment for coating or glazing food products with a sauce;

FIG. 5 is a side view of the equipment illustrated in FIG. 4;

FIG. 6 is a perspective view of a portion of the equipment illustrated in FIG. 4;

FIG. 7 is a perspective side view of another exemplary embodiment of equipment for coating or glazing food products with a sauce;

FIG. 8 is a front view of the equipment illustrated in FIG. 7, further illustrating a portion of a conveyor;

FIG. 9 is a front perspective view of the equipment illustrated in FIG. 7;

FIG. 10 is a front view of another exemplary embodiment of equipment for coating or glazing food products with a sauce;

FIG. 11 is a top view of the equipment illustrated in FIG. 10;

FIG. 12 is a side view of the equipment illustrated in FIG. 10;

FIG. 13 is a cross-sectional side view of the equipment of FIG. 10 taken along section line A-A of FIG. 12;

FIG. 14 is an enlarged view of the portion of the equipment of FIG. 13 designated by circle B; and

FIG. 15 is an side view of a portion of the equipment illustrated in FIG. 10.

### DETAILED DESCRIPTION

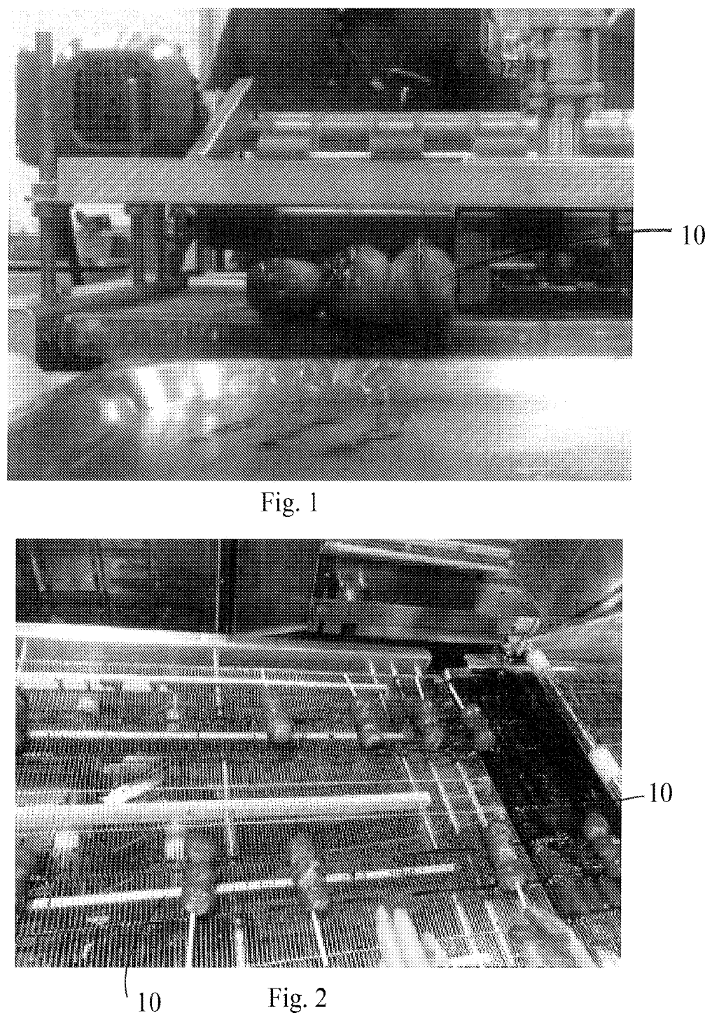

Referring now to the Figures, wherein the components are labeled with like numerals throughout the several Figures, and initially to FIGS. 1 and 2, multiple meatballs 10 on skewers are shown after a coating layer of sauce has been applied to their outer surfaces using equipment and processes described herein. In particular, FIG. 1 illustrates three meatballs 10 on a skewer as they are exiting equipment where their outer surfaces were coated with sauce, while FIG. 2 illustrates multiple skewers with meatballs 10 after they have been coated with sauce and as they are being moved along a conveyor to another processing step.

In accordance with exemplary embodiments of the equipment and processes described herein, minimal to no sauce will be applied to the portion of skewers that extend beyond the meatballs 10, and minimal to no sauce will be applied in the areas of the meatballs 10 closest to the skewers. That is, sauce will generally be applied to the outer perimeter surfaces of the meatballs 10 that are furthest from the skewers.

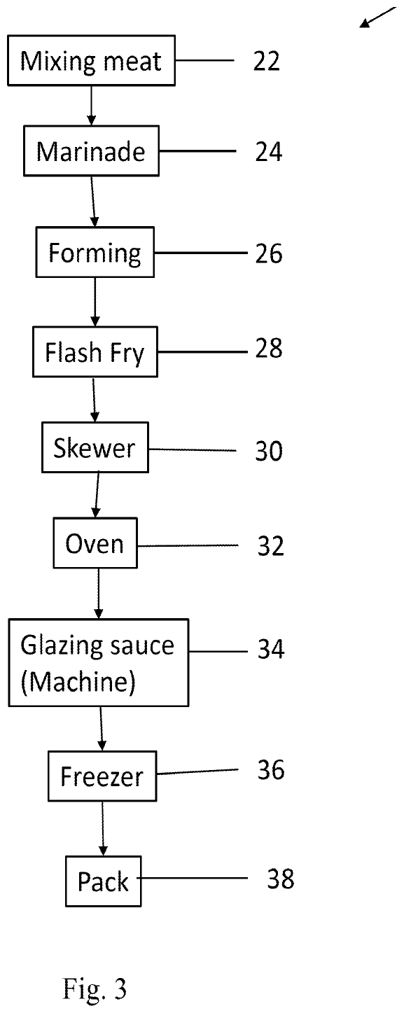

FIG. 3 is a flow chart of an exemplary method 20 for producing food products using the sauce application equipment and methods described herein, which are intended to be illustrative. In some embodiments, method 20 may be accomplished with one or more additional operations not described, and/or without one or more of the operations described. Additionally, the order in which the operations of method 20 are illustrated in FIG. 3 and described below is not intended to be limiting.

In some embodiments, steps of the method 20 may be controlled by one or more processing devices that electronically process information to coordinate the various process steps. The processing devices may include one or more devices executing some or all of the operations of method 20 in response to instructions stored electronically on an electronic storage medium. The processing devices may include one or more devices configured through hardware, firmware, and/or software to be specifically designed for execution of one or more of the operations of method 20.

With continued reference to FIG. 3, the illustrated method 20 generally includes providing raw food mixture (e.g., minced meat (e.g., chicken, pork, fish, or other meat mixtures and/or products), egg, ginger, grated onion, soy sauce, spices, and/or other ingredients) to a production line where a number of processing steps occur. Such a food mixture is only intended to be representative, however, and it is understood that a wide variety of different ingredients may instead be used, including food mixtures that do not include any meat products. For example, fruits, vegetables, and other food items or mixtures may be used with the methods and equipment described herein. Therefore, it is understood that the description herein that refers to meatballs is intended to encompass similar processing of other food items. In any case, after the processing steps described herein are completed, the processed food items will generally be frozen and packaged so that the only further steps that a consumer will need to take will be removing these frozen food products from the packaging and cooking the items in some type of oven by following provided instructions.

Method 20 includes a step or operation 22 in which a raw food mixture is blended or mixed until a desired consistency is achieved. The food mixture can also optionally be marinated or otherwise processed, as represented by step or operation 24. The marinade may include a wide variety of ingredients, such as a relatively homogeneous solution including water, seasoning, spices, salts, sauces, sugar, starch, flavoring, emulsifier and/or the like. The marinade can vary widely, depending on the recipe and the desired taste and texture for the end product. After the mixing and optional incorporation of a marinade into the food mixture, it will then be ready for further processing.

The next step 26 includes forming the food mixture into individual balls, which are referred to herein as “meatballs” although it is understood, as described above, that the mixture in some cases may not include any meat products and in fact may include food items such as fruits or vegetables that are already provided in their final form. In cases where a meat mixture is provided for step 26, meatballs may be formed by hand in one example. However, a forming machine can instead be used to automatically or semi-automatically form the meatballs into a particular desired shape and size. Further, a weighing and/or dispensing machine may be used to provide metered portions of the food mixture to the forming operation. Often, the shape of the meatballs formed will be generally spherical, although it is contemplated that the meatballs can be shaped to a different regular or irregular shape. The formed meatballs will be place on a conveyor or other surface for transporting them to the next stage of the process. In an exemplary embodiment, each piece or meatball weighs can be in the range of approximately 35 grams to approximately 45 grams, although the size of each piece can be slightly or considerably smaller or larger than this exemplary weight.

Optionally, the meatballs may then pass through an inspection station where the items can be weighed and/or visually inspected. In an alternative, the meatballs can be formed off-site or in a location that is not “in-line” with the other processing steps. In such a case, the meatballs can be supplied in bulk to a hopper or other large vessel that includes features that allow the meatballs to be deposited in a controlled manner onto a conveyor in a single layer. Alternatively, the food items can be removed from a bulk container by hand and placed in particular locations on a moving conveyor.

The formed meatballs are then conveyed to a first fryer in which they are deep fried in an edible oil in a first frying step or operation 28. These food items are fried (e.g., “flash fried”) at a suitable temperature and time to provide a desired pre-cooking or cooking of their outer surface. In this way, the outer surface of the meatballs will be hardened at least slightly so that the product shape will be “fixed” for the upcoming skewering step. One way of controlling the amount of frying can be by varying the speed of a conveyor on which the food items are moved through the process. The meatballs may optionally be conveyed to a second fryer after the first frying step. In an exemplary process, the meatballs will be fried in a first fryer in oil that is at a temperature of approximately 190 degrees Celsius for approximately 60 seconds, and then fried in a second fryer in oil that is at a temperature of approximately 160 degrees Celsius for approximately 130 seconds. The times and temperatures can vary slightly or considerably from these exemplary frying parameters. At least a portion of the inside of the meatballs will not be completely cooked after the frying step(s) and may have a core temperature of approximately 50-60 degrees Celsius, for example.

The fried or partially fried food items are then conveyed to a skewering station where a skewering operation 30 takes place. In this step, one or more operators can be positioned relative to a conveyor so that the individual meatballs can be picked up and penetrated with a skewer (e.g., a bamboo skewer). This skewering process can be manually or automatically performed. In exemplary illustrated embodiments, three of such meatballs are placed on each skewer, although more or less than three meatballs are possible. In general, it is desired for a portion of the skewer to extend beyond the meatballs so that a consumer can grasp this portion without having to touch the meatballs.

The skewered meatballs are then conveyed to an oven in which they are further cooked, as is represented by step or operation 32. This step involves baking the skewered meatballs at a suitable temperature and time to achieve a desired cooking of the meatballs. In an exemplary embodiment, the oven temperature will be approximately 125 degrees Celsius and the meatballs will be cooked at this temperature for approximately 11 to 14 minutes and/or until their core temperature is in a range of approximately 70-88 degrees Celsius. The cooking time and temperature can vary slightly or considerably from this exemplary embodiment, depending on the size of the meatballs, the amount of pre-cooking that has been done, and a wide variety of other factors. In an exemplary operation, the meatballs will be moved through the oven via a conveyor. Either before or after exiting the oven, the skewered meatballs can be manipulated either manually or automatically so that the length of the skewers is generally perpendicular to the direction they are being conveyed.

The skewered meatballs are then conveyed to a glazing machine where glaze or sauce is applied to the outer surface of the skewered meatballs, as is represented by the glazing step 34. In general, such a glazing machine includes one or more belts (e.g., mesh belts), conveyors, and/or rollers to move the skewered meatballs forward to pass through a lower sauce tray. The conveyor includes openings or spaces through which the sauce can come in contact with the food items being conveyed on its upper surface. An upper conveyor or belt can be provided that includes multiple apertures or a mesh pattern. The conveyors may be positioned so that the upper conveyor or belt contacts the products being conveyed by the lower conveyor. The speed of the upper and lower conveyors can be running at the same or different speeds so that when both conveyors are in contact with the meatballs, the skewered meatballs will rotate about the axis of their associated skewer during the glazing operation. Further details of exemplary equipment contemplated for this glazing step are described and illustrated herein.

The glaze used with the equipment and methods for this glazing step described herein can have a wide variety of properties, depending on the desired taste, texture, and the like for the end product. A wide range of glaze viscosities may be used, where an exemplary glaze can have a viscosity range of between 40 seconds to 1 minute. In any case, the sauce used for glazing will be selected to provide a desired texture and taste for the end food product.

After the glazing step is complete, the meatballs can be further conveyed to a freezing station where they will be held for the time required to adequately freeze the meatballs, as is represented by freezing step 36. In an exemplary process, the products will be quick frozen by a spiral freezer at a temperature lower than approximately-22 degrees Celsius. The frozen items can then be removed from the freezer and packaged for shipment to consumers, as is represented by packaging step 38. The frozen items may also be stored in a cold storage location before or after shipment from the processing area.

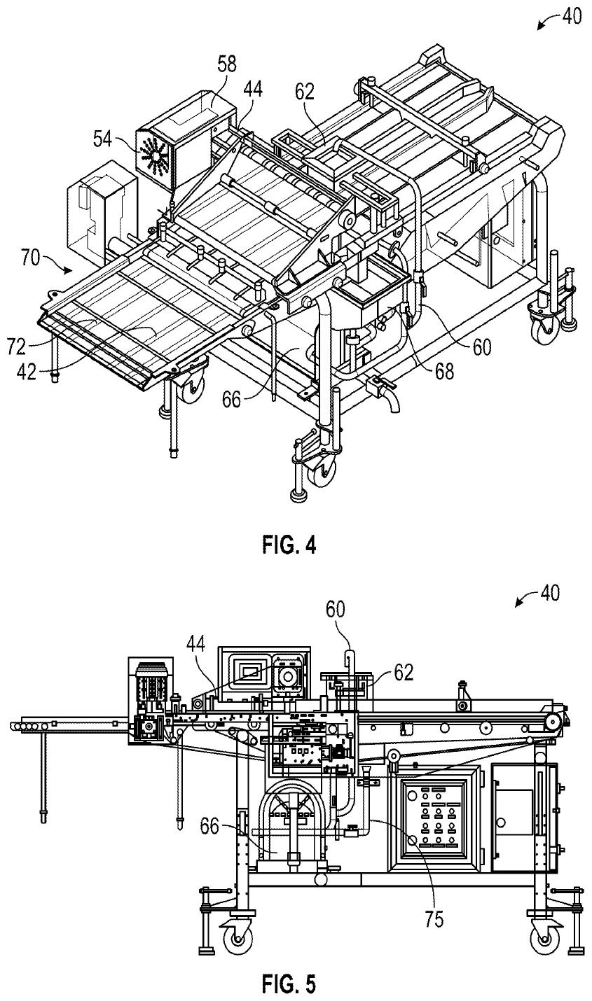

Referring now to FIGS. 4-6, various views are provided of an exemplary embodiment of a glazing machine or equipment 40 for coating or glazing food products with a sauce. This machine 40 is designed to perform the glazing step 34 discussed above relative to the exemplary method of FIG. 3. In general, the machine 40 includes a lower conveyor 42 along which food products can be moved during the glazing process, and guide supports 44 for an upper conveyor (not illustrated in this figure in order to more clearly illustrate the other components of machine 40). Referring to FIG. 5, for example, the upper conveyor can be moving in a clockwise direction while the lower conveyor is moving in a counterclockwise direction. The speed at which the upper and lower conveyors are moving relative to each other can be adjusted and coordinated to cause food items such as skewered meatballs to rotate while sauce is transferred to their outer surfaces. In an embodiment, the conveyor speeds are coordinated so at least one full rotation of the meatballs occurs during a glazing operation, thereby allowing sauce to be applied to the entire outer perimeter of the meatballs.

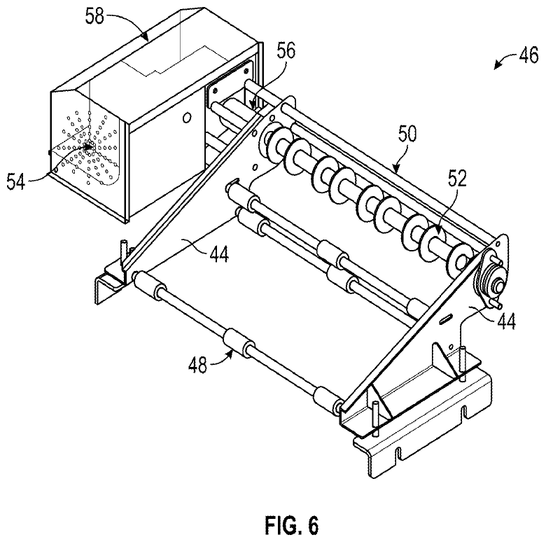

As is best shown in FIG. 6, the upper portion of the glazing machine 40 includes an upper belt system 46 having two guide supports 44 positioned across the width of the machine 40. Upper belt system 46 includes a number of shaft rollers 48 extending between guide supports 44, and at least one main shaft 50. Upper belt system 46 further includes an upper drive shaft 52 coupled via coupling 56 to a motor 54 for controlling rotation of the drive shaft 52. The motor 54 may be protected by a motor cover 58. For clarity of illustration, FIG. 6 does not show the conveyor belt that will be positioned around these rollers and guide supports. However, in operation, a conveyor belt made of mesh or another material will be supported by these rollers and guide supports for clockwise movement (as viewed from the right side of the upper belt system 46 of FIG. 6).

The glazing machine 40 may also include a guide system 70 (see FIG. 4, for example) including multiple guide rails 72 spaced from each other across the width of the lower conveyor 40 that are positioned to support a conveyor belt (e.g., a wire mesh conveyor belt). A space is provided under these rails 72 (and the conveyor belt) to which sauce is provided from a supply tank (as is described below).

Glazing machine 40 includes a sauce filling pipe or tube 60 through which sauce is moved from a main sauce supply tank 68 to move sauce to a sauce dispenser or tray 62. A pump (not shown) that is covered by a pump cover 66 provides for this movement of sauce from the supply tank 68 to the sauce filling pipe or tube 60. The amount of sauce being supplied can be controlled by adjusting the speed of the pump, as desired. The space under the rails 72 and associated conveyor belt acts as a sauce tray that is supplied with sauce from the supply tank 68. This sauce is deep enough that it contacts the lower conveyor 40 on which the meatballs are positioned. When the lower conveyor 40 is running, meatballs that are being conveyed are passing through this sauce. As the meatballs roll on the conveyor surface, the outside meatball is coated or glazed with a desired amount of sauce.

A gap or slot can be provided between the sauce dispenser 62 and a central area into which sauce is being supplied, wherein the gap or slot is positioned above the path of a top side or edge of the top or first meatball of a skewered meatball product. In this way, sauce will flow via gravity through this gap or slot as the skewered meatballs are moving along the bottom conveyor, thereby applying sauce to the top side or edge of the top or first meatball of each skewer.

Glazing machine 40 may further include components and features for recycling sauce that overflows or is otherwise unused by the glazing process. Such recycling can be facilitated by a pipe or tube 75 that returns excess sauce to the pump 66 for reusing the sauce in the glazing process described above.

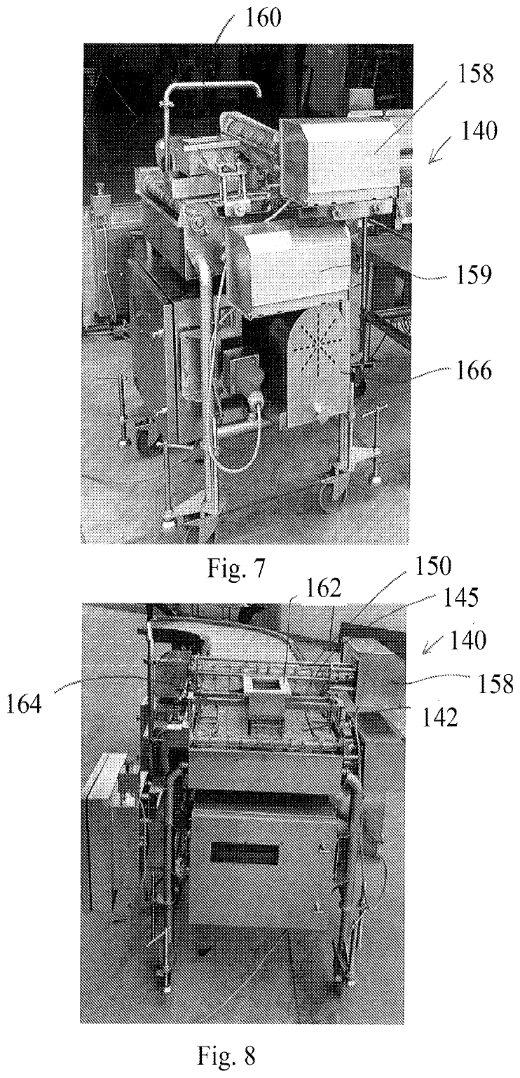

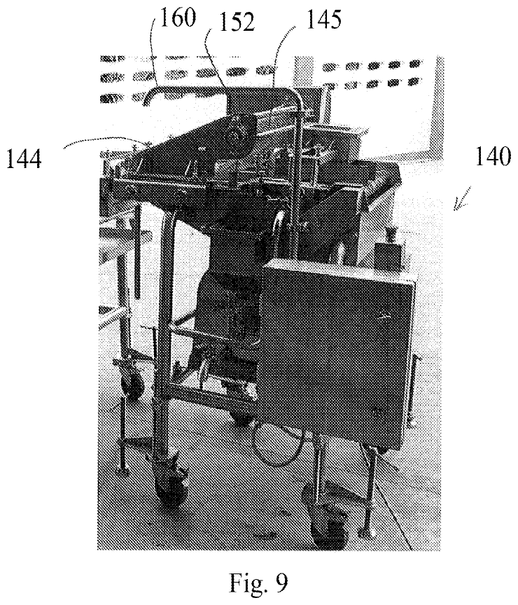

Referring now to FIGS. 7-9, various views are provided of another exemplary embodiment of a glazing machine or equipment 140 for coating or glazing food products with a sauce. This machine 140 is designed to perform the glazing step 34 discussed above relative to the exemplary method of FIG. 3. In general, the machine 140 includes a lower conveyor 142 along which food products can be conveyed during the glazing process, and guide supports 144 for an upper conveyor 145. Referring to FIG. 9, for example, the upper conveyor can be moving in a clockwise direction while the lower conveyor is moving in a counterclockwise direction. The speed at which the lower and upper conveyors 142, 145 are moving relative to each other can be adjusted and coordinated to so that food items that are in contact with both conveyors, such as skewered meatballs, are forced to rotate while sauce is being applied to their outer surfaces. In an embodiment, the conveyor speeds are coordinated so at least one full rotation of the meatballs occurs during the glazing operation, thereby allowing sauce to be applied to the entire outer perimeter of the meatballs.

The upper portion of the glazing machine 140 includes an upper belt system having two guide supports 144 positioned across the width of the machine 140. The upper belt system includes a number of shaft rollers extending between guide supports 144 and at least one main shaft 150, similar to that described above relative to upper belt system 46. The upper belt system is driven by an upper belt motor (not visible in this Figure) for controlling rotation of the drive shaft 152. The upper belt motor may be protected by a motor cover 158. The lower conveyor 142 is driven by a lower belt motor (not visible in this Figure) that is protected by a lower belt motor cover 159

Glazing machine 140 further includes a sauce filling pipe or tube 160 through which sauce is moved from a main sauce supply tank to supply sauce to a sauce dispenser or tray 162. A pump (not shown) that is covered by a pump cover 166 provides for this movement of sauce from the supply tank to the sauce filling pipe or tube 160. The amount of sauce being supplied can be controlled by adjusting the speed of the pump, as desired. A tray or space for sauce is positioned under the lower conveyor belt so that when food products are moved along the conveyor in the area of this tray or space, they will contact the sauce. This sauce will be transferred to the meatballs to provide a desired amount of glaze or sauce on their outside surface.

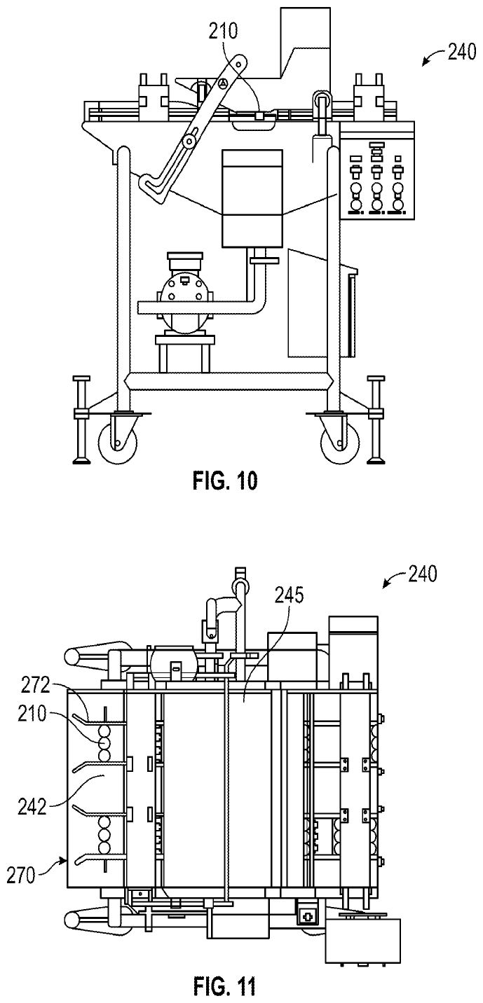

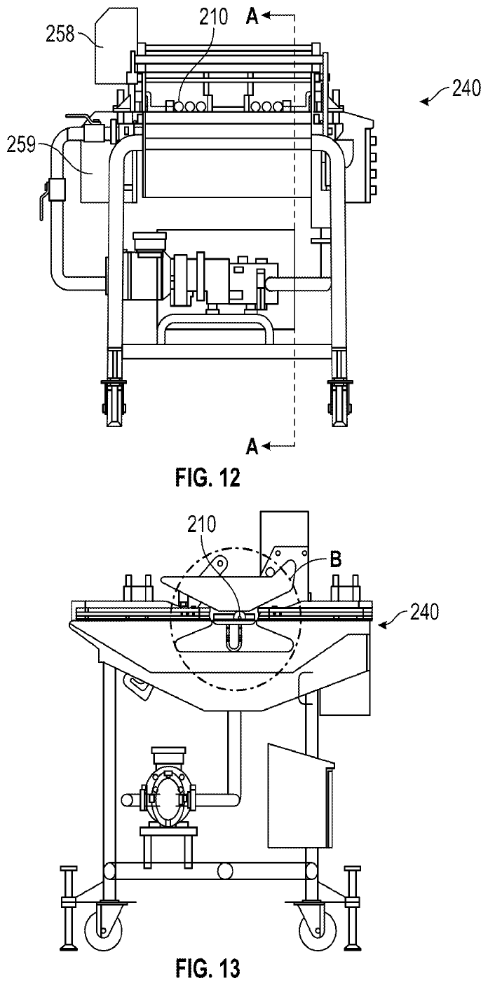

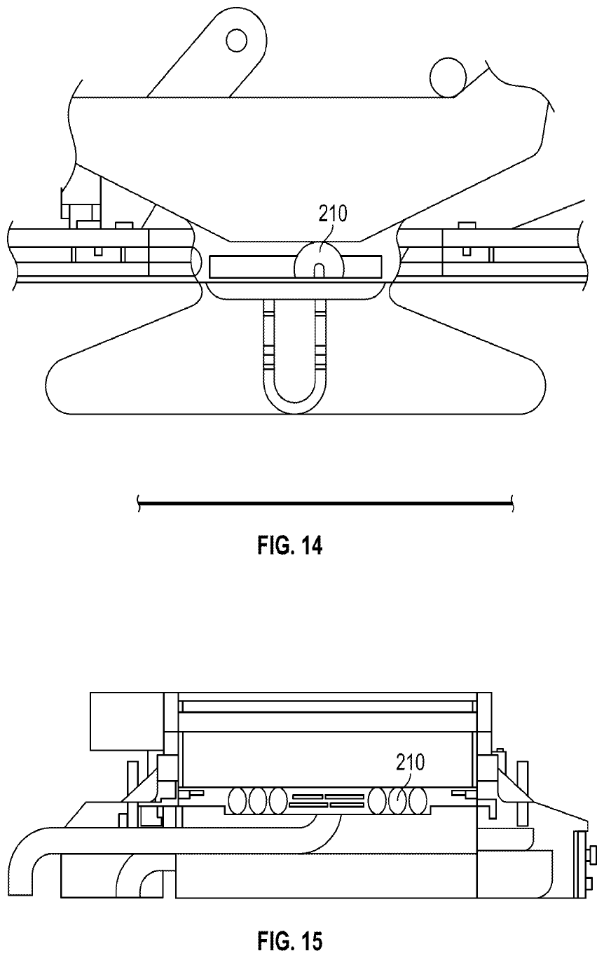

Referring now to FIGS. 10-15, various views are provided of another exemplary embodiment of a glazing machine or equipment 240 for coating or glazing food products with a sauce. In this depiction of a glazing machine 240, skewered meatballs 210 are shown in several of the figures, wherein the movement of these meatballs is from the right side of the machine or equipment 240 of FIG. 10 toward the left side of the machine or equipment 240. This machine 240 is designed to perform the glazing step 34 discussed above relative to the exemplary method of FIG. 3. In general, the machine 240 includes a lower conveyor 242 along which food products can be conveyed during the glazing process, and an upper conveyor 245. The speed at which the lower and upper conveyors 242, 245 are moving relative to each other can be adjusted and coordinated to cause the food items that are in contact with both conveyors, such as skewered meatballs 210, to rotate while sauce is being applied to their outer surfaces. In an embodiment, the conveyor speeds are coordinated so at least one full rotation of the meatballs 210 occurs during the glazing process, thereby allowing sauce to be applied to the entire outer perimeter of the meatballs.

The glazing machine 240 may also include a guide system 270 including multiple guide rails 272 spaced from each other across the width of the lower conveyor which are positioned to support a conveyor belt (e.g., a wire mesh conveyor belt). A space is provided under these rails 272 (and the conveyor belt) to which sauce is provided from a supply tank.

The upper portion of the glazing machine 240 includes an upper belt having a number of shaft rollers extending between guide supports and at least one main shaft, similar to that described above relative to upper belt system 46. The upper belt system is driven by an upper belt motor (not visible in this Figure) for controlling rotation of the drive shaft 252. The upper belt motor may be protected by a upper belt motor cover 258. The lower conveyor 242 is driven by a lower belt motor (not visible in this Figure) that is protected by a lower belt motor cover 259.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. The implementations described above and other implementations are within the scope of the following claims.

1. An automated glazing machine for applying sauce to at least one food product, the glazing machine comprising:
a lower conveyor comprising a top surface moving in a first direction;
an upper conveyor comprising a bottom surface moving in a second direction that is different from the first direction, wherein the upper conveyor is spaced from the lower conveyor at a glazing location by a distance that allows the at least one food product to simultaneously contact the bottom surface of the upper conveyor and the top surface of the lower conveyor; and
a sauce tray positioned below the lower conveyor to transfer sauce to the at least one food product at the glazing location.

2. The automated glazing machine of claim 1, wherein the lower conveyor comprises a mesh conveyor.

3. The automated glazing machine of claim 1, wherein the lower conveyor and upper conveyor are configured to move at different speeds.

4. The automated glazing machine of claim 1, wherein the lower conveyor and upper conveyor configured to move at generally the same speed.

5. The automated glazing machine of claim 1, further comprising a sauce supply tube for pumping sauce from a sauce supply tank to the sauce tray.

6. A method of coating a sauce onto skewered food products, comprising the steps of:
positioning a skewered food product on a top surface of a lower conveyor;
conveying the skewered food product toward a glazing location of an automated glazing machine, wherein the glazing location comprises an upper conveyor comprising a bottom surface and a lower conveyor comprising a top surface, and wherein the upper and lower conveyors are spaced at a distance from each other so that the skewered food products simultaneously contact the bottom surface of the upper conveyor and the top surface of the lower conveyor at the glazing location; and
transferring sauce to an outer surface of the skewered food product as it is conveyed through the glazing location.

7. The method of claim 6, wherein the at least one skewered food product rotates about a central skewer when being conveyed through the glazing location.

8. The method of claim 6, further comprising a step of transferring sauce to a sauce tray positioned under the lower conveyor at the glazing location during the step of transferring sauce to an outer surface of the skewered food product.

9. The method of claim 8, wherein the sauce is continually being transferred to the sauce tray.

10. The method of claim 6, wherein the upper and lower conveyors are moving in different directions.

11. The method of claim 6, wherein the upper and lower conveyors are moving at generally the same speed.

12. The method of claim 6, wherein the upper and lower conveyors are moving at different speeds.
